(19) United States
(12) Patent Application Publication
(10) Pub. No.: US 2003/0101191 A1
(43) Pub. Date: May 29, 2003

(54) Publication of commercial entity information and method for classifying commercial entity information

(76) Inventor: Yu-Chwin Lin, Taipei (TW)

Correspondence Address: SNELL & WILMER, ONE ARIZONA CENTER, 400 EAST VAN BUREN, PHOENIX, AZ, 850040001

(21) Appl. No.: 10/306,213

(22) Filed: Nov. 27, 2002

(30) Foreign Application Priority Data
Nov. 28, 2001 (TW) 090129405

(51) Int. Cl. G06F 7/00

(52) U.S. Cl. 707/100

(57) ABSTRACT

The present invention relates to a publication of commercial entity information and method for classifying commercial entity information. First, the present invention classifies a plurality of commercial entity information units into M first-tier subsets according to a business-type criterion. Then, the present invention selectively classifies each of the M first-tier subsets into P first compound subsets according to a first criterion. And the present invention selectively classifies each of the M first-tier subsets into N second compound subsets according to a second criterion A User is able to quickly search for information in a publication classified by the present invention

This application claims priority of Taiwan Patent Application Serial No. 090129405 filed on Nov. 28, 2001.

### FIELD OF INVENTION

The present invention relates to a publication of commercial entity information and method for classifying commercial entity information, and more particularly, to a publication having a plurality of catalogues and method for hierarchically classifying commercial entity information of a publication.

### BACKGROUND OF THE INVENTION

Publications, such as many telephone directories, magazines, and books, generally classify commercial entity information for user's convenience. As shown in FIG. 1, the conventional telephone directory classifies the commercial entity information 11 into many first-tier subsets 12 according to a business-type criterion. For instance, the conventional telephone directory classifies the store providing Chinese food into a category of Chinese restaurant, and classifies the store providing pizza into a category of pizzeria. The categories of Chinese restaurant and pizzeria are first-tier subsets 12.

Furthermore, many telephone directories classify first-tier subsets 12 into many second-tier subsets 13 according a specific criterion. For instance, many telephone directories classify the Chinese restaurants, pizzeria, or the beverage retailers into a category of “food”, and classify the commercial entities providing construction engineering, interior decorations, or security systems into a category of home/housing according to a living requirement criterion. The categories of “food” and “home/housing” are second-tier subsets 13. Other second-tier subsets may include “clothing”, “transportation”, “education”, etc.

The conventional publication usually classifies the commercial entity information into first-tier subsets 12 and second-tier subsets 13 according the two criteria mentioned above. Further the publication edits two catalogues based on first-tier subsets 12 and second-tier subsets 13. The first catalogue maps to the information of first-tier subsets 12. The second catalogue maps to the information of second-tier subsets 13.

The telephone directory having the two catalogues provides two search ways for users. FIG. 2 (a) discloses the first search way. First, in step 21, a user determines to which first-tier subset a commodity of interest belongs. In step 22, the user obtains information by looking up the first catalogue according to the first-tier subset determined in step 21. FIG. 2 (b) discloses the second search way. In step 25, a user first determines which second-tier subset a commodity of interest belongs to. By consulting with the second catalogue, user obtains information in step 26. Afterwards, in step 27, user obtains target information of the commodity of interest according to the information. If the user can't determine which second-tier subset the commodity of interest belongs to, he will refer to a classification description in step 28.

When the user intends to obtain the information of a commodity of interest through the conventional telephone directory, he has to determine the category of the commodity of interest of the conventional telephone directory. However, it is not easy for users to correctly classify a commodity of interest into a first-tier subset or a second-tier subset. For example, conventional telephone directory classifies the beauty salon and hair clinic into a category of personal care. Nevertheless, users may not know the beauty salon or hair clinic belong to the category of personal care. Since user has to additionally refer to a classification description, he probably cannot search for target information rapidly. Further, user can't acquire the information of the commodity of interest when he can't obtain extra information from the classification description. For example, a user who plans to buy a Buddhistic table can't acquire the information about the Buddhistic table because he can't determine to which second-tier subset the Buddhistic table belongs. And he may not obtain related information from the classification description.

### SUMMARY OF THE INVENTION

In view of the disadvantage of the prior art, the present invention provides a publication of commercial entity information and method for classifying commercial entity information. The publication of commercial entity collects at least 80% commercial entity information in one specific geographical area. The present invention also provides a method for classifying commercial entity information. The present invention enables users to accelerate the search process.

The present invention provides a publication including a commercial entity information, a first catalogue and a second catalogue. The commercial entity information includes a plurality of commercial entity groups. Each of the commercial entity groups includes a commercial entity information unit. The first catalogue includes a first unit and a second unit. The first unit includes a first unit index and the second unit includes a second unit index. The first unit index and the second unit index selectively map to one identical commercial entity group. The second catalogue includes a third unit. The third unit includes a third unit index. The third unit index maps to one commercial entity group.

Further, the present invention provides a publication including a commercial entity information and a first catalogue. The commercial entity information includes a plurality of commercial entity groups. Each of the commercial entity groups includes a commercial entity information unit. The first catalogue includes of first unit and a second unit. The first unit includes a first index and the second unit includes a second unit index. The first unit index and the second unit index selectively map to one identical commercial entity group.

In addition, the present invention provides a method for classifying commercial entity information. First, the present invention classifies a plurality of commercial entity information units into M first-tier subsets according to a business-type criterion The present invention then selectively classifies each of the M first-tier subsets into P first compound subsets according to a first criterion. Further, the present invention selectively classifies each of the M first-tier subsets into N second compound subsets according to a second criterion.

The present invention provides another method for classifying commercial entity information. First, the present invention classifies a plurality of commercial entity information units into M first-tier subsets according to a business-type criterion. Afterwards, the present invention selectively classifies each of the M first-tier subsets into K compound subsets according to a human activity criterion.

### BRIEF DESCRIPTION OF THE DRAWINGS

FIG. 1 is a schematic diagram of conventional classification method;

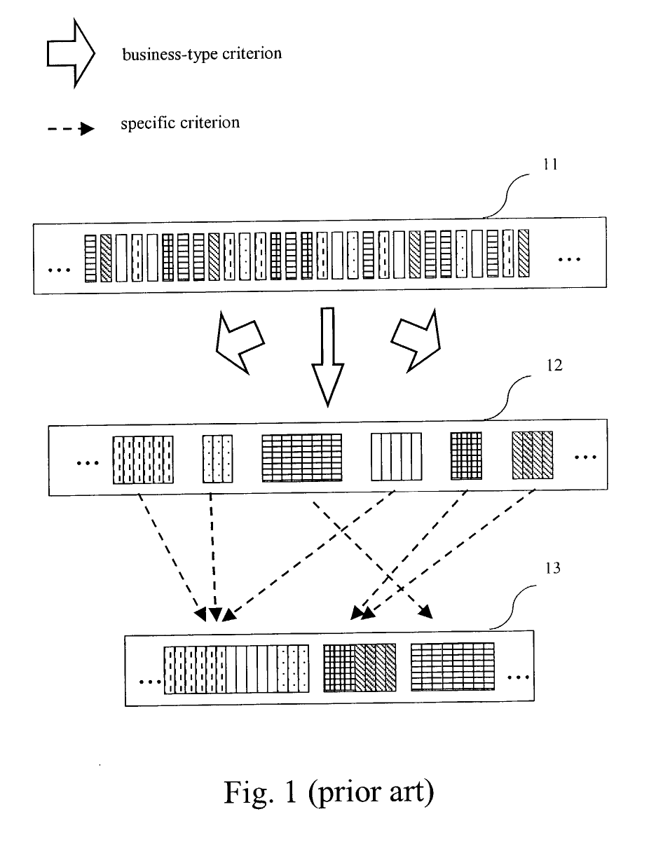

FIG. 2(a) is a flowchart of conventional search process;

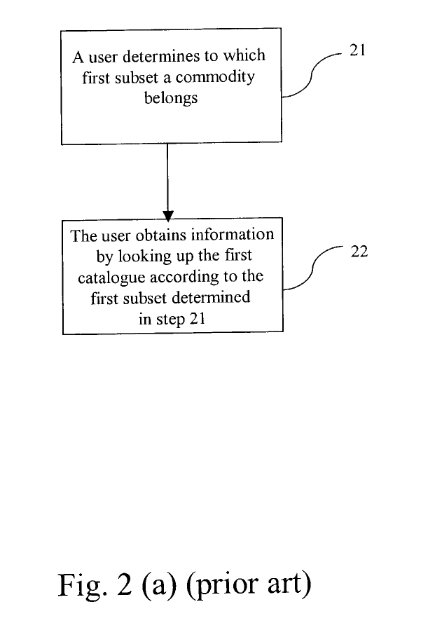

FIG. 2(b) is anther flowchart of conventional search process,

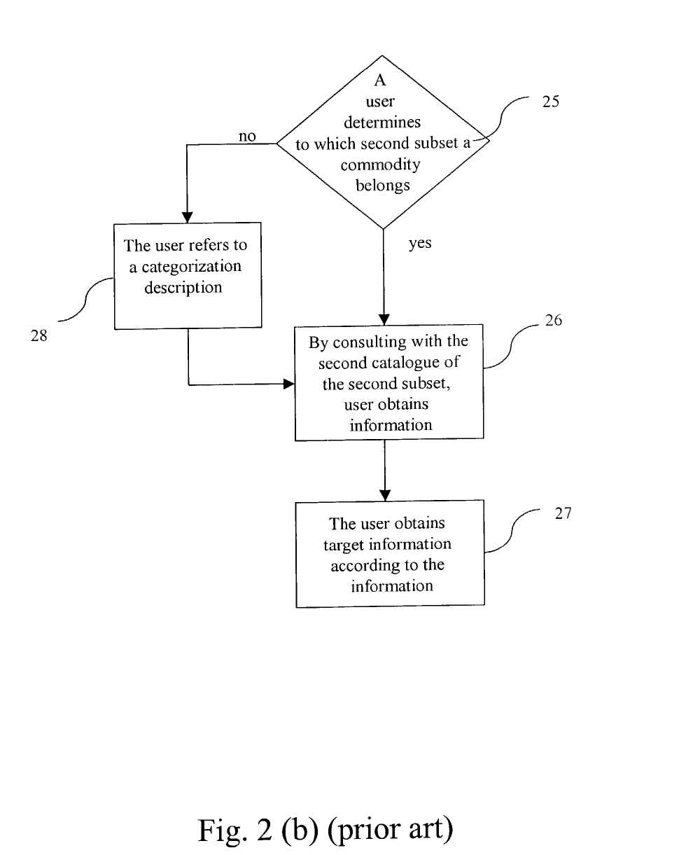

FIG. 3 is a publication of the present invention;

FIG. 4 is a publication including a commercial entity information of present invention;

FIG. 5 is a publication including a first catalogue of the present invention,

FIG. 6 is a publication including a second catalogue of the present invention;

FIG. 7 is a schematic diagram of the present invention;

FIG. 8 is another schematic diagram of the present invention;

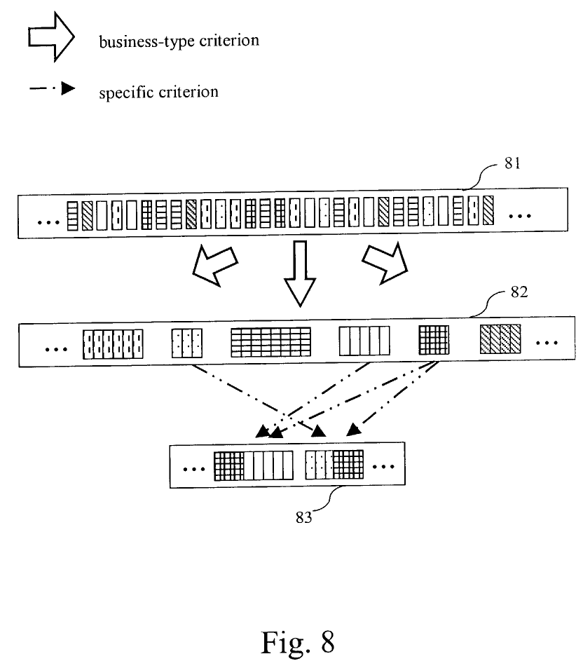

FIG. 9 is a flowchart of the search process provided by the present invention, and

FIG. 10 is an exemplary search process provided by the present invention.

### DETAILED DESCRIPTION OF THE INVENTION

The conventional publication classifies the commercial entity information. However, user cannot search for target information rapidly because of the misperception of commodity of interest.

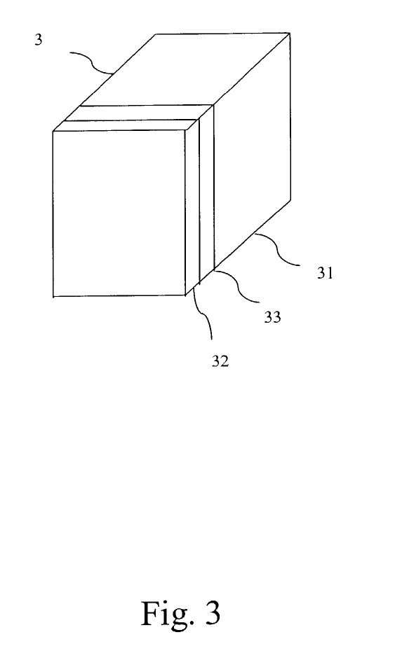

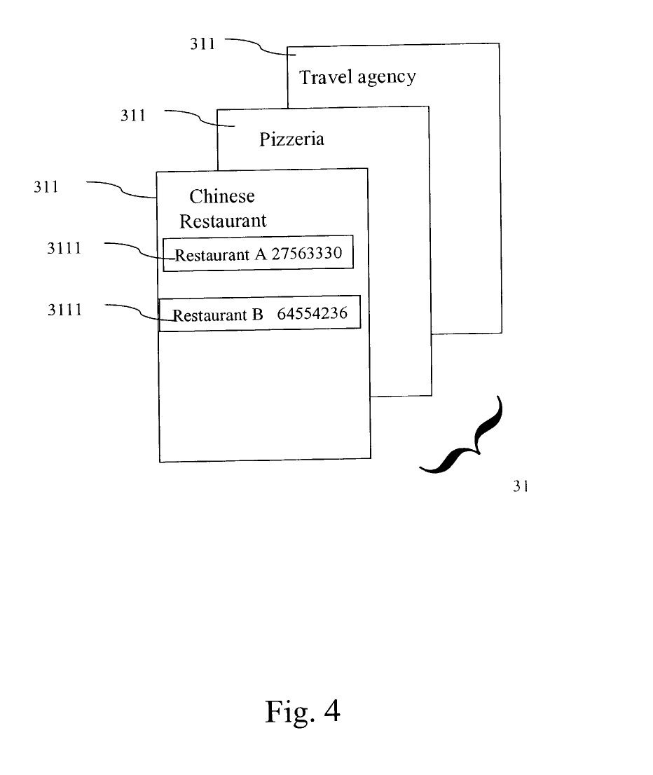

The exemplary embodiment of the present invention provides a publication for user accelerating the search process. The publication collects at least 80% commercial entity information in one specific geographical area. Referring to FIG. 3, FIG. 3 is a publication 3 of the present invention. Publication 3 includes a commercial entity information 31, a first catalogue 32, and a second catalogue 33. As shown in FIG. 4, commercial entity information 31 includes a plurality of commercial entity groups 311, e.g. Chinese restaurant, pizzeria, and travel agency. Each of commercial entity groups 311 includes at least a commercial entity information unit 3111, e.g. restaurant A and restaurant B. Commercial entity information unit 3111 is classified into commercial entity group 311 according to a business-type criterion.

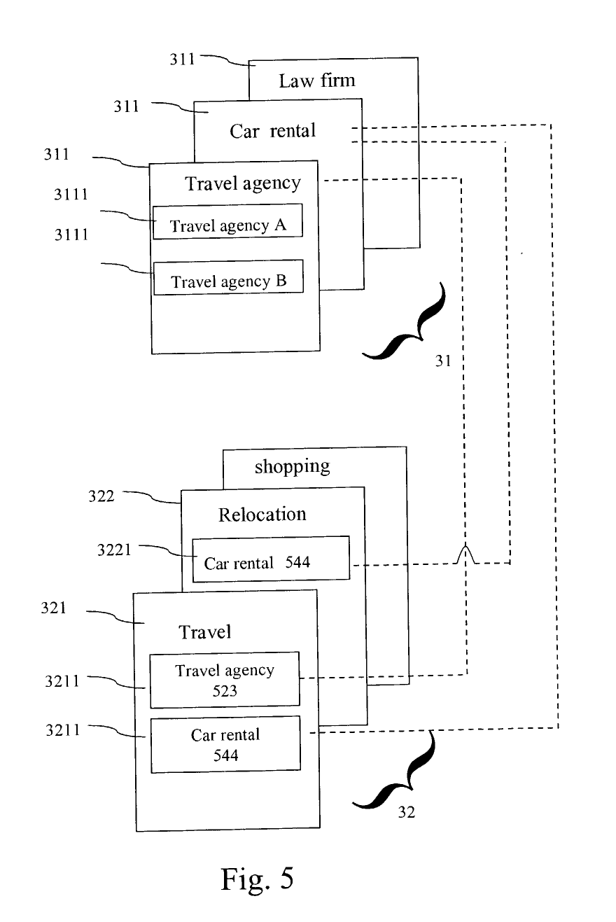

Referring to FIG. 5, FIG. 5 is first catalogue 32 of the publication 3 First catalogue 32 includes a first unit 321 and a second unit 322, e.g travel, and recreation First unit 321 includes a first unit index 3211 and second unit 322 includes a second unit index 3221. First unit index 3211 and second unit index 3221 selectively map to one identical commercial entity group 311. Commercial entity groups 311 selectively mapped by first unit index 3211 and second unit index 3221 are classified according to a human activity criterion.

For example, first unit 321 of travel includes first unit index 3211 of travel agency and first units index 3211 of car rental. Second unit 322 of relocation includes second unit index 3221 of car rental. First unit index 3211 of travel agency maps to commercial entity group 311 of travel. First unit index 3211 of car rental and second unit index 3221 of car rental map to identical commercial entity group 311 of car rental

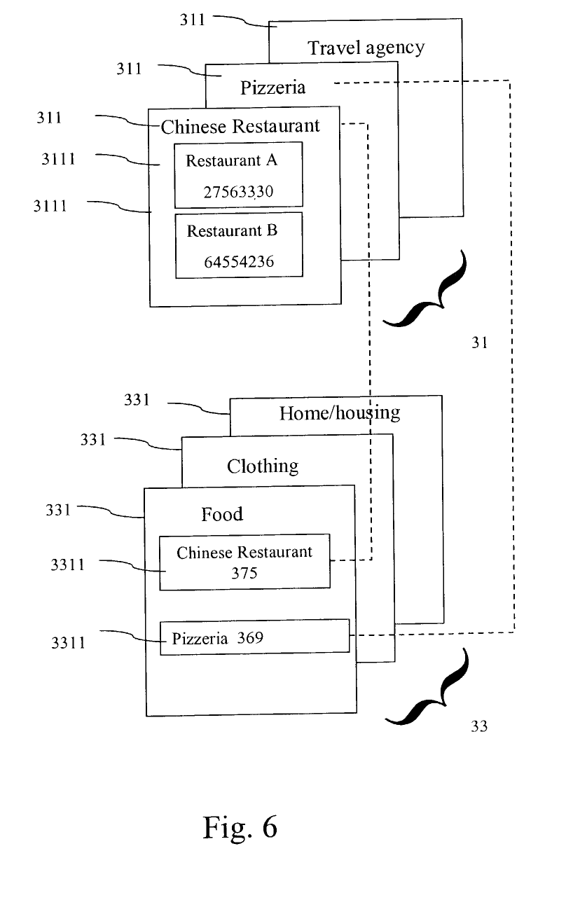

Referring to FIG. 6, FIG. 6 is second catalogue 33 of the publication Second catalogue 33 includes a plurality of third units 331, e.g. food, clothing, and home/housing. Each of third units 331 includes a third unit index 3311. Third unit index 3311 maps to one commercial entity group 311. For example, third unit 331 of Food includes third unit indexes 3311 of Chinese restaurant and pizzeria. Third unit index 3311 of Chinese restaurant maps to commercial entity group 311 of Chinese restaurant. In the exemplary embodiment, commercial entity groups 311 mapped by third unit indexes are classified according to a living requirement criterion.

The present invention also provides a publication including a commercial entity information and a first catalogue. Persons skilled in the art may appreciate the publication is modified according to the publication mentioned above.

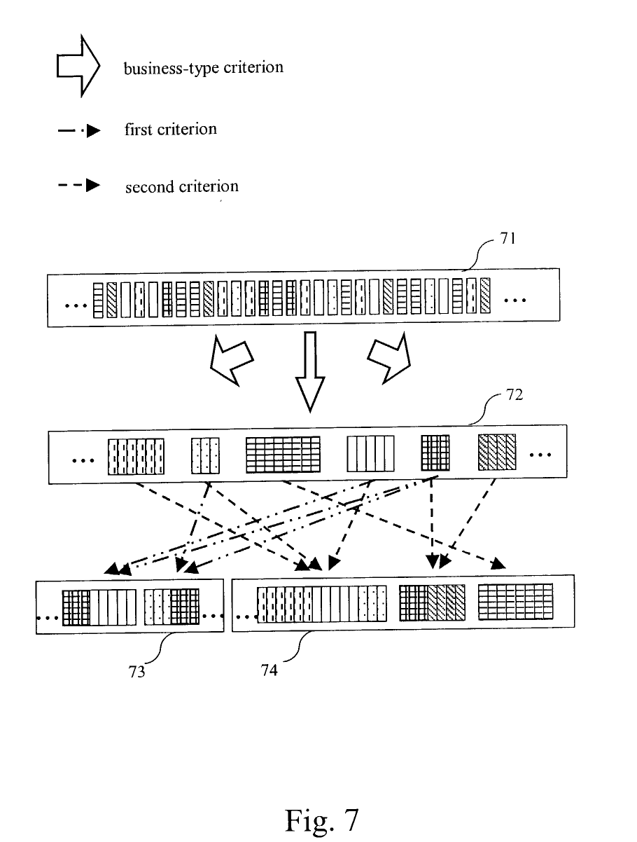

The present invention provides a method for classifying commercial entity information. The publication collects at least 80% commercial entity information in one specific geographical area. As shown in FIG. 7, the present invention classifies a plurality of commercial entity information units 71 into M first-tier subsets 72 according to a business-type criterion. M is a positive integer.

The present invention then selectively classifies each of M first-tier subsets 72 into P first compound subsets 73 according to a first criterion. P is a positive integer. The present invention may selectively classify each of first-tier subsets 72 into P first compound subsets 73 of travel and relocation according to a human activity criterion The ratio of number of unrepeated first-tier subsets of the P first compound subsets to M is less than 20 percent.

Further, the present invention selectively classifies each of M first-tier subsets 72 into N second compound subsets 74 according to a second criterion. N is a positive integer. The present invention may selectively classifies each of M first-tier subsets 72 into second compound subsets 74 of food, clothing, home/housing, recreation, and education according to a living requirement criterion. The ratio of number of unrepeated first-tier subsets of the N second compound subsets to M is greater than 80 percent.

In addition, another exemplary embodiment classifies a plurality of commercial entity information units 81 into M first-tier subsets 82 according to a business-type criterion. Also, the present invention selectively classifies each of the M first-tier subsets 82 into K compound subsets 83 according to a specific criterion, such as human activity criterion. The present invention classifies first-tier subsets 82, such as travel agency, car rental, and hotel, into a compound subset 83 of travel. The present invention classifies first-tier subsets 82, such as golf, sporting goods into a compound subset 83 of recreation.

After classifying a plurality of commercial entity information units into M first-tier subsets according to a business-type criterion, the present invention selectively classifies M first-tier subsets 82 into K compound subsets 83 according to a criterion of Chinese Farmer's Calendar, for example. The Chinese Farmer's Calendar helps people to find lucky days for jia qu (wedding), kai shi (grand opening), yi xi (relocation), an chuang (moving bed), chu xing (travel), jiao yi (business trading), ru lian (encoffin), po tu (break ground), qi fu (pray for good luck) and an zang (entomb), etc. For instance, the present invention classifies first-tier subsets of travel agency, car rental, and hotel into a compound subset of chu xing (travel) according to the criterion of Chinese Farmer's Calendar. The present invention classifies first-tier subsets of real estate agent, insurance, car rental, and bank into a compound subset of yi xi (relocation).

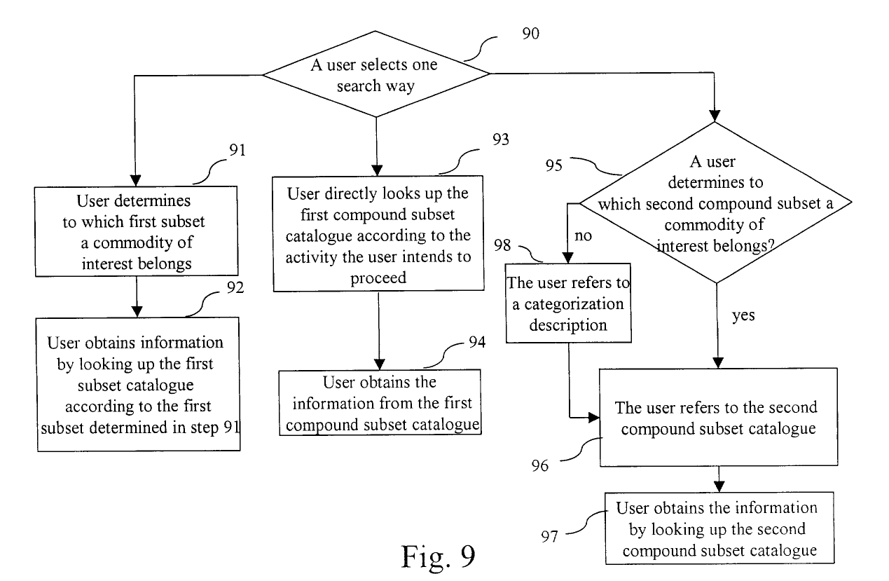

A publication of the present invention provides three search ways for users Refer to FIG. 9. First, a user selects one search way in step 90. By using first search way, user first determines to which first-tier subset a commodity of interest belongs in step 91. In step 92, the user then obtains information by looking up the first-tier subset catalogue according to the first-tier subset determined in step 91. By using second search way, the user directly looks up the first compound subset catalogue according to the activity the user intends to proceed in step 93. Further, in step 94 the user obtains the information from the first compound subset catalogue.

By using third search way, user first determines which second compound subset a commodity of interest belongs to in step 95. In step 96, the user will refer to the second compound subset catalogue if he knows to which second compound subset the commodity of interest belongs. Then, the user obtains the information by referring to the second compound subset catalogue in step 97. The user will refer to a classification description if he doesn't know to which second compound subset the commodity of interest belongs in step 98. The user may determine the second compound subset of the commodity of interest and may refer to the second compound subset catalogue in step 96. Afterwards, in step 97 the user obtains the information by looking up the second compound subset catalogue.

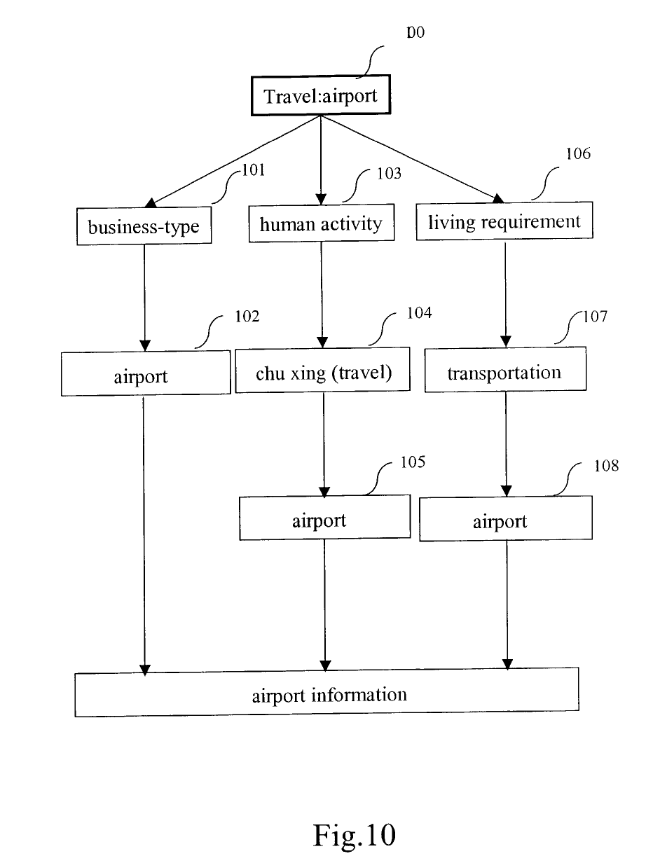

FIG. 10 shows an exemplary search process provided by the present invention In step 100, a user intends to search for airport information. He may select three search ways. In step 101, the user decides the business-type of airport by using first search way. In step 102, the user further obtains the airport information by looking up the business-type catalogue. Since the user plans to travel in step 103, he refers to the category of chu xing (travel) in the Chinese Farmer Calendar catalogue in step 104 by using second search way. Then, in step 105 the user obtains the airport information in the category of chu xing (travel). By using third search way, the user has to predetermine that the airport belongs to the category of transportation according to the living requirement criterion in step 106. In step 107, the user looks up the transportation information in the living requirement catalogue. Last, the user acquires the airport information in step 108.

While this invention has been described with reference to an illustrative embodiment, this embodiment is not intended to be construed in a limiting sense. Various modifications of the illustrative embodiment, as well as other embodiments of the invention, will be apparent to persons skilled in the art upon reference to this description. It is therefore contemplated that the appended claims will cover any such modifications or embodiments as falling within the true scope of the invention.

1. A publication, comprising:
a commercial entity information including a plurality of commercial entity groups, each of said commercial entity groups including a commercial entity information unit;
a first catalogue including a first unit and a second unit, said first unit including a first unit index, said second unit including a second unit index, said first unit index and said second unit index selectively mapping to one identical commercial entity group; and
a second catalogue including a third unit, said third unit including a third unit index, said third unit index mapping to one commercial entity group

2. The publication of claim 1, wherein said commercial entity information unit is classified into said commercial entity group according to a business-type criterion.

3. The publication of claim 1, wherein said commercial entity group selectively mapped by said first unit index and said second unit index is classified according to a human activity criterion.

4. The publication of claim 3, wherein said human activity criterion is a classification criterion of Chinese Farmer's Calendar.

5. The publication of claim 1, wherein said commercial entity group mapped by said third unit index is classified according to a living requirement criterion.

6. A publication, comprising:
a commercial entity information including a plurality of commercial entity groups, each of said commercial entity groups including a commercial entity information unit; and
a first catalogue including a first unit and a second unit, said first unit including a first unit index, said second unit including a second unit index, said first unit index and said second unit index selectively mapping to one identical commercial entity group.

7. The publication of claim 6, wherein said commercial entity information unit is classified into said commercial entity group according to a business-type criterion.

8. The publication of claim 6, wherein said commercial entity group selectively mapped by said first unit index and said second unit index is classified according to a human activity criterion.

9. The publication of claim 8, wherein said human activity criterion is a classification criterion of Chinese Farmer's Calendar.

10. A method for classifying commercial entity information of a publication, comprising:
classifying a plurality of commercial entity information units into M first-tier subsets according to a business-type criterion, M being a positive integer,
selectively classifying each of said M first-tier subsets into P first compound subsets according to a first criterion, P being a positive integer, and
selectively classifying each of said M first-tier subsets into N second compound subsets according to a second criterion, N being a positive integer

11. The method of claim 10, wherein said first criterion is a human activity criterion

12. The method of claim 11, wherein said human activity criterion is a classification criterion of Chinese Farmer's Calendar.

13. The method of claim 10, wherein said second criterion is a living requirement criterion.

14. The method of claim 10, wherein a ratio of number of unrepeated first-tier subsets of said P first compound subsets to M is less than 20 percent

15. The method of claim 10, wherein a ratio of number of unrepeated first-tier subsets of said N second compound subsets to M is greater than 80 percent

16. A method for classifying commercial entity information of a publication, comprising:
classifying a plurality of commercial entity information units into M first-tier subsets according to a business-type criterion, M being a positive integer, and
selectively classifying each of said M first-tier subsets into K compound subsets according to a criterion, K being a positive integer

17. The method of claim 16, wherein said criterion is a human activity criterion

18. The method of claim 17, wherein said human activity criterion is a classification criterion of Chinese Farmer's Calendar.

19. The method of claim 16, wherein a ratio of number of unrepeated first-tier subsets of said K compound subsets to M is less than 20 percent.
